(19) United States
(12) Patent Application Publication
(10) Pub. No.: US 2003/0013477 A1
(43) Pub. Date: Jan. 16, 2003

(54) Controlling dual processors in cellular telephones

(76) Inventor: Paul McAlinden, Austin, TX (US)

Correspondence Address: Timothy N. Trop, TROP, PRUNER & HU, P.C., STE 100, 8554 KATY FWY, HOUSTON, TX, 77024-1805, US

(21) Appl. No.: 09/904,334

(22) Filed: Jul. 12, 2001

(51) Int. Cl. H04M 1/00

(52) U.S. Cl. 455/550; 455/556; 455/404; 455/8

(57) ABSTRACT

A cellular telephone using a pair of processors may include a bypass device. The bypass device may be active when a first processor is not responding. In such case, inputs from a keypad or outputs to the display may bypass the first processor allowing continued communication between input/output devices and the second processor. In some embodiments, the first processor may be an applications processor and the second processor may be a baseband processor.

### BACKGROUND

This invention relates generally to cellular telephones.

Cellular telephones may include the processing power to implement both baseband communications and additional applications and functions such as call handling functions, personal digital assistant functions, note pad functions, calculator functions, entertainment functions and address book functions, to mention a few examples.

In some cases, cellular telephones may include a pair of processors. These processors may be separately integrated or may be integrated together on the same integrated circuit. One processor may primarily handle baseband communication related tasks and may be called the baseband processor. The other processor, called the applications processor, generally handles inputs and outputs and all applications other than those directly related to baseband processing. For example, the entertainment, calculator, personal digital assistant, note pad, and address book functions may be handled in whole or in part by an applications processor.

Referring to FIG. 3, a conventional architecture for a cellular telephone 10a may include an antenna 12 coupled to a radio frequency interface 14. The interface 14 may communicate via bus 15 with a baseband processor 16a. The processor 16a may include a memory 18.

A bus 20a enables communications between the baseband processor 16a and the applications processor 22a. The applications processor 22a may include a memory 24.

In one architecture, the applications processor 22a handles all inputs and outputs including inputs from the keypad 30 and the outputs to the display 28. The keypad 30 may be utilized to select various input commands for applications and may also be used to provide telephone numbers for dialing. Thus, in some cases, it may be desirable for the baseband processor 16a to receive information from the keypad 30.

Generally, user outputs from the baseband processor 16a are routed to the display 28 via software running on the applications processor 22a via the interface 20a. Similarly, user inputs from the keypad 28 travel in the reverse direction. If the applications processor 22a is in a sleep mode, the baseband processor 16a may be unable to immediately access the display 28 or the keypad 30. In order to access those functions, the baseband processor 16a may need to awaken the applications processor 22a. This may adversely effect power conservation of the applications processor 22a and may also result in a time delay inherent in awakening the applications processor 22a.

Moreover, if there is a problem with the applications processor 22a resulting, for example, from a software error, the baseband processor 16a may be disabled from enabling call dialing. In some cases, if the applications processor is disabled the telephone may be prevented from accessing emergency services for example.

Thus, there is a need to enable the baseband processor to communicate with input and output devices when the applications processor 22a is unavailable.

### BRIEF DESCRIPTION OF THE DRAWINGS

FIG. 1 is a block depiction of one embodiment in accordance with the present invention;

FIG. 2 is a flow chart in accordance with one embodiment of the present invention; and

FIG. 3 is a block depiction of a device in accordance with the prior art.

### DETAILED DESCRIPTION

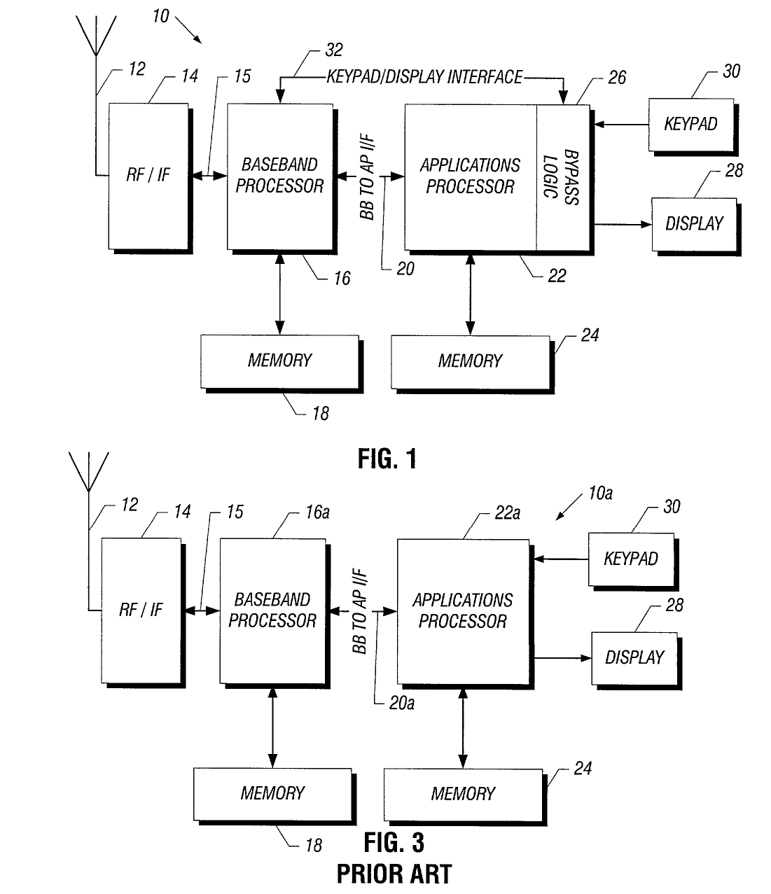

Referring to FIG. 1, a cellular telephone 10 may include an antenna 12 coupled to a radio frequency interface 14. The cellular telephone 10 may be in accordance with any of the available communications standards. The interface 14 communicates with the baseband processor 16 over a bus 15. Likewise, the baseband processor 16 communicates with an applications processor 22 over an interface 20. The baseband processor 16 may be coupled to a memory 18 and the applications processor 22 may be coupled to a memory 24. In some embodiments, both the baseband processor 16 and applications processor 22 are integrated into the same integrated circuit. In other embodiments, they may be on separate integrated circuits.

The applications processor 22 may include bypass logic 26. In some embodiments, the bypass logic 26 may be a separate integrated circuit. In some embodiments, the bypass logic 26 may be hard wired logic and in other embodiments, the bypass logic 26 may be a processor-based controller. The bypass logic 26 communicates with the keypad 30 and the display 28 and forwards keypad 30 inputs to the applications processor 22 and outputs signals to the display 28 from the applications processor 22 during normal operations.

When the applications processor 22 is unavailable, the bypass logic 26 automatically shunts inputs from the keypad 30 to the baseband processor 16 over the interface 32. Likewise outputs from the baseband processor 16 may be shunted via the bypass logic 26 directly to the display 28.

In some embodiments, even if the applications processor 22 is unavailable, for example because it is a sleep mode or because of a software problem, the bypass logic 26 may function to enable communications with the baseband processor 16.

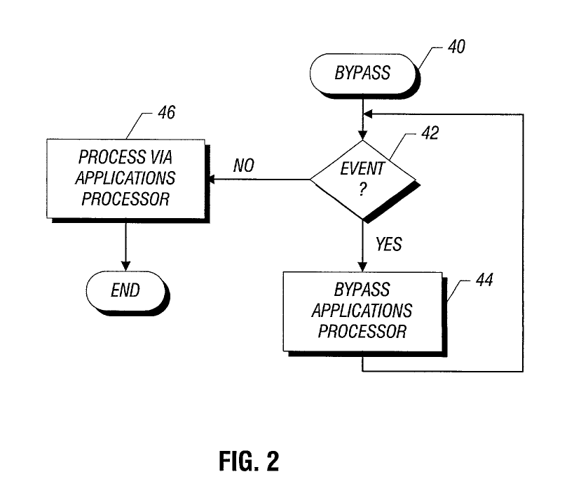

Referring to FIG. 2, the bypass logic 26 may operate using software 40 or may use hard wired logic that accomplishes the functions illustrated in FIG. 2. Initially, a check at diamond 42 determines whether an event has occurred. The event may be the failure of the applications processor 22 to respond to a query from the baseband processor 16. Similarly, the event may be the failure of the applications processor 22 to respond to a query from the bypass logic 26. In effect, the bypass logic 26 may search for a heartbeat signal from the applications processor 22 indicating that the applications processor 22 is functioning correctly.

If such an event is detected, the applications processor 22 may be bypassed by the bypass logic 26 using the interface 32 as indicated in block 44. Otherwise, inputs and outputs may be processed normally by passing those signals to the applications processor 22 as indicated in block 46.

If the applications processor is not responding, this may be detected and the applications processor 22 bypassed. Thus, in making an emergency call, the keypad 30 may be operated and the information entered is automatically directed to the baseband processor 16 to complete a call. Similarly, outputs from the baseband processor 16 to the display 28 also bypass the applications processor 22, for example, to enable the dialed number to be displayed on the display 28.

In one embodiment, when an emergency call is being made, for example, by dialing the number 911, if the applications processor 22 fails to respond within a certain amount of time, the applications processor 22 may be automatically bypassed by the bypass logic 26. The logic 26 may recognize the number 911 and may determine whether or not the applications processor 22 is responding within a predetermined amount of time. If not, the keypad entries are automatically shunted to the baseband processor 16.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A cellular telephone comprising:
a first processor;
a second processor;
a first bus coupling said first and second processors; and
a device to selectively bypass the first processor.

2. The telephone of claim 1 wherein said first processor is an applications processor.

3. The telephone of claim 1 including a keypad, said first processor coupled to said keypad to receive keypad inputs.

4. The telephone of claim 1 including a display, said first processor coupled to said display to provide outputs to said display.

5. The telephone of claim 2 wherein said second processor is a baseband processor.

6. The telephone of claim 1 wherein said device selectively bypasses the first processor if the first processor fails to respond.

7. The telephone of claim 1 wherein the second processor selectively bypasses the first processor to make an emergency call.

8. The telephone of claim 1 wherein said telephone includes a keypad, keypad entries being provided to said first processor, said device selectively shunting said keypad entries to said second processor.

9. The telephone of claim 1 including a display, said display coupled to receive outputs from said first processor, said device to selectively bypass the first processor to provide outputs to said display from said second processor.

10. The telephone of claim 1 including a display and a keypad, said first processor coupled to said display and said keypad and said second processor coupled to said display and said keypad through said first processor and said device.

11. A method comprising:
establishing communications between an input/output device and a first processor; and
in response to the detection of an event, providing said communications to a second processor.

12. The method of claim 11 including selectively coupling keypad entries to a second processor when a first processor fails to respond.

13. The method of claim 11 including coupling keypad entries directly to the first processor except when the first processor fails to respond.

14. The method of claim 11 including detecting an emergency call and in response to the detection of an emergency call, coupling keypad entries directly to a baseband processor.

15. The method of claim 11 wherein detecting an event includes detecting the failure of a first processor to respond.

16. The method of claim 15 including detecting the failure of the first processor to respond within a predetermined amount of time.

17. The method of claim 11 including coupling said second processor to said first processor and coupling said first processor directly to a keypad and a display.

18. The method of claim 17 including selectively coupling said display and said keypad directly to said second processor.

19. The method of claim 11 including providing a first processor which acts as an applications processor.

20. The method of claim 19 including providing a second processor that acts as a baseband processor.

21. An article comprising a medium storing instructions that enable a processor-based system to:
establish communications between an input/output device and a first processor; and
in response to the detection of an event, provide said communications to a second processor.

22. The article of claim 21 further storing instructions that enable the processor-based system to selectively couple keypad entries to a second processor when a first processor fails to respond.

23. The article of claim 21 further storing instructions that enable the processor-based system to couple keypad entries directly to the first processor except when the first processor fails to respond.

24. The article of claim 21 further storing instructions that enable the processor-based system to detect an emergency call and in response to the detection of an emergency call, couple the keypad entries directly to a baseband processor.

25. The article of claim 12 further storing instructions that enable the processor-based system to detect the failure of the first processor to respond.

26. The article of claim 25 further storing instructions that enable the processor-based system to detect the failure of the first processor to respond within a predetermined amount of time.

27. The article of claim 21 further storing instructions that enable the processor-based system to couple said second processor to said first processor and couple said first processor directly to a keypad and a display.

28. The article of claim 27 further storing instructions that enable the processor-based system to selectively couple said display and said keypad directly to said second processor.

29. The article of claim 21 further storing instructions that enable the processor-based system to establish communications between an input/output device and a first processor that is an applications processor.

30. The article of claim 29 further storing instructions that enable the processor-based system to provide a second processor that acts as a baseband processor.
